(19) United States
(12) Patent Application Publication
(10) Pub. No.: US 2023/0349702 A1
(43) Pub. Date: Nov. 2, 2023

(54) SYSTEMS AND METHODS TO FOLLOW A VEHICLE USING ALTERNATIVE FORMS OF NAVIGATION ASSISTANCE

(71) Applicant: Ford Global Technologies, LLC, Dearborn, MI (US)

(72) Inventors: Taylor Hawley, Oak Park, MI (US); Jeremy Lerner, Southfield, MI (US); Ali Abdallah, Dearborn, MI (US); Scott Huggins, Novi, MI (US); Danielle Rosenblatt, Madison Heights, MI (US); Mohammad Abouali, Canton, MI (US)

(73) Assignee: Ford Global Technologies, LLC, Dearborn, MI (US)

(21) Appl. No.: 17/660,974

(22) Filed: Apr. 27, 2022

(51) Int. Cl. H04W 4/46; G01C 21/34; H04W 4/024

(52) U.S. Cl. CPC G01C 21/3415; G01C 21/3438; H04W 4/024; H04W 4/46

(57) ABSTRACT

The disclosure is generally directed to systems and methods for one vehicle to follow another vehicle using alternative types of navigation assistance. In a first example method, a first vehicle uses a first type of navigation assistance to follow a second vehicle. The first type of navigation assistance can be based on satellite signals. A navigation system provided in the first vehicle may detect a loss of the first type of navigation assistance. The first vehicle may then follow the second vehicle to an intermediate location along the travel route, based on a second type of navigation assistance. In an example scenario, the second type of navigation assistance is based on a wireless signal containing information of a travel route of the second vehicle. The wireless signal may be generated by a device located in the second vehicle and/or by a device located outside the second vehicle.

### BACKGROUND

A driver of a first vehicle may desire to follow a driver of a second vehicle to a destination, via an unfamiliar route. One way to do so is to follow the second vehicle while keeping the second vehicle constantly in sight. However, under certain circumstances, the driver may lose sight of the second vehicle and may be forced to find an alternative method to follow the second vehicle. At least some of the alternative methods may prove unsatisfactory or inadequate. It is therefore desirable to address this issue.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates a first example scenario associated with a vehicle following system in accordance with an embodiment of the disclosure.

FIG. 2 illustrates a second example scenario associated with a vehicle following system in accordance with an embodiment of the disclosure.

FIG. 3 illustrates a first example flowchart of a method for one vehicle to follow another vehicle in accordance with an embodiment of the disclosure.

FIG. 4 illustrates a second example flowchart of another method for one vehicle to follow another vehicle in accordance with an embodiment of the disclosure.

FIG. 5 shows some example components that may be included in a navigation device in accordance with an embodiment of the disclosure.

FIG. 6 shows some example components that may be included in a computer (such as, for example, a cloud computer) in accordance with an embodiment of the disclosure.

### DETAILED DESCRIPTION

### Overview

In terms of a general overview, this disclosure is generally directed to systems and methods for one vehicle to follow another vehicle using alternative navigation assistance. A first example method in accordance with the disclosure, includes providing a first routing direction for a first vehicle that is following a route of a second vehicle, said first routing direction based on a first type of navigation assistance; detecting, by the first vehicle, a loss of the first type of navigation assistance; and providing a second routing direction for the first vehicle following the route of the second vehicle, said second routing direction based on a second type of navigation assistance.

A second example method in accordance with the disclosure, includes determining, while on a travel route, a request associated with a follower vehicle for navigation assistance to follow a lead vehicle moving on the travel route; requesting navigation assistance from the lead vehicle for following the lead vehicle on the travel route; and receiving from the lead vehicle by the follower vehicle, the navigation assistance that enables the follower vehicle to rendezvous with the lead vehicle.

An example first vehicle includes a vehicle computer, a communication system, and a navigation system. The navigation system includes a memory that stores computer-executable instructions and a processor configured to access the memory and execute the computer-executable instructions to receive a first routing direction for following a route of a second vehicle, said first routing direction based on a first type of navigation assistance; detect a loss of the first type of navigation assistance; and receive a second routing direction based on a second type of navigation assistance.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the word “vehicle” as used in this disclosure can pertain to any one of various types of vehicles such as cars, vans, sports utility vehicles, trucks, electric vehicles, gasoline vehicles, hybrid vehicles, and autonomous vehicles. The word “vehicle” as used in this disclosure may also encompass water craft such as, for example, a boat, a yacht, or any vehicle that travels on water. Words such as “follow” and “following” as used in this disclosure should be interpreted as being synonymous with certain words such as “track,” “shadow,” “stalk,” “pursue,” and “pursuit,” but only in such cases that are within the bounds of the applicable laws, including lawful activity by law enforcement. Regardless of the term, operations associated with these words are carried out with a driver of a lead vehicle being aware of a follower vehicle following the lead vehicle, having given permission to a follower vehicle to follow the lead vehicle, or other lawful operations.

It must also be understood that words such as “implementation,” “scenario,” “case,” “instance,” and “situation” as used herein are an abbreviated version of the phrase “In an example (“implementation,” “scenario,” “case,” “approach,” “instance,” and “situation”) in accordance with the disclosure.” Furthermore, the word “example” as used herein is intended to be non-exclusionary and non-limiting in nature.

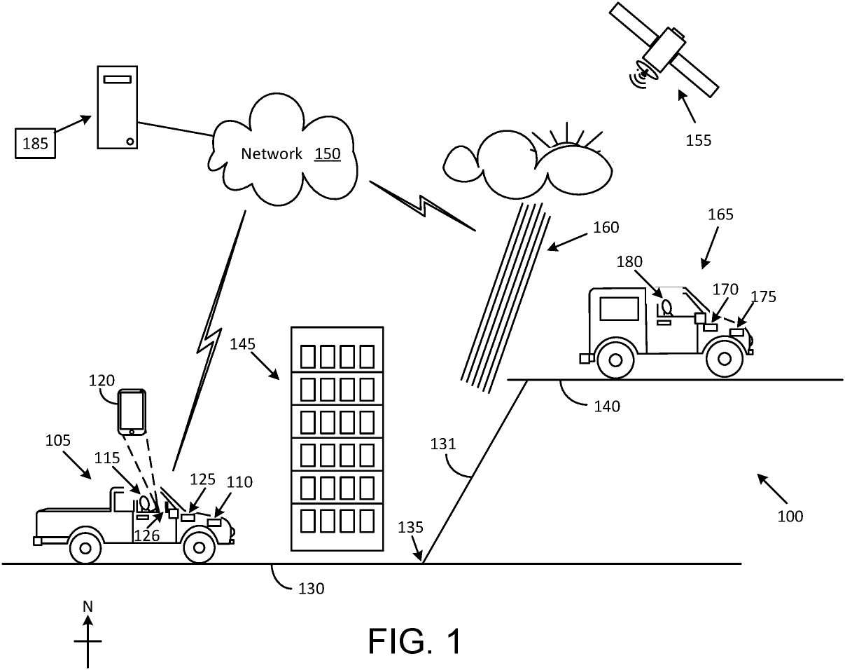

FIG. 1 illustrates a first example scenario associated with a vehicle following system 100 in accordance with an embodiment of the disclosure. The vehicle following system 100 includes a first set of devices that may be provided in a vehicle 105, a second set of devices that may be provided in a vehicle 165, and a computer 185. In various scenarios, the computer 185 can be any of various types of computers such as, for example, a personal computer, a server computer, a client computer, or a cloud computer.

In an example implementation, the vehicle 105 and/or the vehicle 165 can be autonomous vehicles. In another example implementation, the vehicle 105 (and/or the vehicle 165) can be a driver-operated vehicle. In the illustrated scenario, the vehicle 105 is operated by a driver 115 and the vehicle 165 is operated by a driver 180. When the vehicle 105 is an autonomous vehicle, the actions described herein with respect to the driver 115 may be executed autonomously by a computer provided in the vehicle 105. Similarly, when the vehicle 165 is an autonomous vehicle, the actions described herein with respect to the driver 180 may be executed autonomously by a computer provided in the vehicle 165. Furthermore, it must be understood that the actions described herein with respect to the vehicle 105 and the vehicle 165, which are illustrated as vehicles that move on a ground surface (road, dirt track, etc.), may be equally applicable to vehicles that move on water (boat, yacht, etc.).

The driver 115 of the vehicle 105 has a personal device 120. The personal device 120 can be any of various portable devices such as, for example, a smartphone, a tablet computer, a phablet (phone plus tablet computer), or a wearable device (smartwatch, for example). In an example embodiment, the personal device 120 is configured to offer some, or all, of the functionalities described herein with reference to the navigation system 125.

The first set of devices provided in the vehicle 105 can include a vehicle computer 110, an infotainment system 126, and a navigation system 125. The vehicle computer 110, the navigation system 125, the personal device 120, the infotainment system 126, and other devices (not shown) in the vehicle 105 may be communicatively coupled to each other wirelessly and/or via a wired bus. Wireless communications may be implemented using wireless technologies such as, for example, Bluetooth®, Zigbee®, UWB, or near-field-communications (NFC). The wired bus can be implemented using one or more of various wired technologies. For example, the bus can be a vehicle bus that uses a controller area network (CAN) bus protocol, a Media Oriented Systems Transport (MOST) bus protocol, and/or a CAN flexible data (CAN-FD) bus protocol.

The vehicle computer 110 may perform various functions such as, for example, controlling engine operations (fuel injection, speed control, emissions control, braking, etc.), managing climate controls (air conditioning, heating etc.), activating airbags, and issuing warnings (check engine light, bulb failure, low tire pressure, vehicle in blind spot, etc.). The vehicle computer 110 may further perform certain operations in response to communications received from the navigation system 125. The communications can include, for example, directives pertaining to actions that are to be implemented by the vehicle computer 110 upon the vehicle 105 in accordance with the disclosure.

The navigation system 125 provides navigation assistance to the driver 115. In an example scenario, the navigation system 125 receives signals from one or more global positioning system (GPS) satellites (illustrated in the form of a GPS satellite 155) and uses the satellite signals to display a route map on a display screen of the infotainment system 126.

The navigation system 125 further includes hardware and/or software that enables various operations in accordance with the disclosure. For example, the navigation system 125 can include a communications system that supports wireless communications between the navigation system 125 and various devices such as, for example, the vehicle computer 110 and a navigation system 170 provided in the vehicle 165. The navigation system 125 further includes hardware and software that enable the navigation system 125 to execute various operations when the vehicle 105 follows the vehicle 165 in accordance with the disclosure. An example operation involves receiving navigation assistance from the navigation system 170 of the vehicle 165 and/or from the computer 185.

The second set of devices provided in the vehicle 165 can include a vehicle computer 175 and the navigation system 170. The second set of devices may be communicatively coupled to each other wirelessly or via a wired bus in a manner similar to that described above. The vehicle computer 175 of the vehicle 165 can perform various operations such as the operations described above with reference to the vehicle computer 110 of the vehicle 105.

The navigation system 170 can provide navigation assistance to the driver 180 of the vehicle 165 in the manner described above with reference to the navigation system 125. The navigation system 170 further includes hardware and/or software that enables various operations in accordance with the disclosure. For example, the navigation system 170 can include a communications system that supports wireless communications between the navigation system 170 and various devices such as, for example, the vehicle computer 175 of the vehicle 165 and the navigation system 125 of the vehicle 105.

The navigation system 170 further includes hardware and software that enable the navigation system 170 to execute various operations associated with the vehicle 165 when the vehicle 165 is operating as a lead vehicle for the vehicle 105, in accordance with the disclosure. An example operation involves transmitting information associated with navigation assistance, to various devices such as, for example, to the navigation system 125 of the vehicle 105 and/or to the computer 185. In an example scenario, the information relates to a travel route followed (or expected to be followed) by the vehicle 165 when traveling to a destination that is an intended destination of the vehicle 105 as well.

Communications between the navigation system 170 of the vehicle 165, the navigation system 125 of the vehicle 105, and the computer 185, may be conducted via a network 150. The network 150 may include any one, or a combination of networks, such as a local area network (LAN), a wide area network (WAN), a telephone network, a cellular network, a cable network, a wireless network, and/or private/public networks such as the Internet. For example, the network 150 may support communication technologies such as TCP/IP, cellular, Bluetooth®, Zigbee®, UWB, or near-field-communications (NFC), Wi-Fi, Wi-Fi direct, machine-to-machine communication, man-to-machine communication, and/or a vehicle-to-everything (V2X) communication. V2X communication technology encompasses vehicle-to-vehicle (V2V) communications and vehicle-to-infrastructure (V2I) communications that may bypass the network 150 in some cases.

In an example scenario in accordance with the disclosure, the navigation system 125 of the vehicle 105 may cooperate with the vehicle computer 110 of the vehicle 105 to enable the vehicle 105 to follow the vehicle 165 to a destination. The vehicle 165, which operates as a lead vehicle in this scenario, may travel east over a first period of time on a road 130 that is a part of a travel route to the destination. The driver 115 of the vehicle 105 (which operates as a follower vehicle in this scenario) can follow the vehicle 165, for example, with the permission of the driver 115, by using various forms of navigation assistance.

In one example scenario, the driver 115 of the vehicle 105 may travel towards the destination by referring to a travel route displayed upon a display screen of the infotainment system 126 by the navigation system 125. In another example scenario, the driver 115 of the vehicle 105 may travel towards the destination by referring to a travel route that is generated by the personal device 120 and displayed upon a display screen of the personal device 120.

The travel route may be generated based on satellite signals, more particularly, based on satellite signals provided by the GPS satellite 155. This form of navigation assistance may be feasible as long as the satellite signals are available. However, in an example scenario, the satellite signals may be blocked by a building 145 or may be lost due to inclement weather (indicated in the form of rain 160). At this time, the driver 115 may seek help in the form of an alternative form of navigation assistance to replace the navigation assistance offered by use of the satellite signals.

In another example scenario, the driver 115 of the vehicle 105 may seek the consent of the driver 180 of the vehicle 165 to travel towards the destination by obtaining the help of the vehicle 165. The driver 180 of the vehicle 165 may grant consent and provide navigation assistance to the driver 115 of the vehicle 105 by driving in a manner that establishes a line-of-sight relationship between the vehicle 105 and the vehicle 165. In some embodiments, consent may be express, such as though a request (e.g., a help request as decribed herein) sent by the driver 115 and an responsive approval issued by the driver 165, or it may be based on a preference or setting allowing third party vehicles to follow independent of a request and approval. In some situations, the line-of-sight relationship may be lost, such as, for example, when the vehicle 165 turns away from the road 130 at a road junction 135 and travels in a north-easterly direction on a road 131. In this situation, the building 145, which is located near the road junction 135, obscures the view of the vehicle 165 to the driver 115 of the vehicle 105, and leads to a loss of the line-of-sight relationship between the vehicle 105 and the vehicle 165. The travel route in this example scenario includes the road 130, the road 131, and a road 140. The road junction 135 is one example of an intermediate location along the travel route.

The driver 115 may respond to the loss of the line-of-sight relationship by seeking help from the navigation system 125 in accordance with the disclosure. The help may be sought, for example, by activating a “help” icon on a display screen of the infotainment system 126. The navigation system 125 may respond to the indication by providing an alternative form of navigation assistance to replace the first form of navigation assistance (the line-of-sight relationship).

In an example scenario in accordance with the disclosure, the navigation system 125 of the vehicle 105 may respond to the help sought by the driver 115, by establishing wireless communication with the navigation system 170 of the vehicle 165. The wireless communication may be established, for example, via the network 150 using communication formats such as, for example, cellular, Wi-Fi, or Wi-Fi direct. The wireless communication may also be established via direct communication links between the vehicle 105 and the vehicle 165 using communications formats such as vehicle-to-everything (V2X) communications, for example.

After wireless communication has been established, the navigation system 125 of the vehicle 105 may receive a wireless signal from the navigation system 170 of the vehicle 165. In one case, the wireless signal may contain information about an end-to-end travel route of the vehicle 165 (including a portion of the travel route that has been traversed prior to the moment when the driver 115 seeks help). In another case, the wireless signal may contain information about a section of the travel route of the vehicle 165 that extends from the location at which the driver 115 seeks help.

Information about the end-to-end travel route may, for example, be stored in the navigation system 170 of the vehicle 165 prior to a start of travel of the vehicle 165 on the travel route. The information may be subsequently provided to the navigation system 125 of the vehicle 105 on an as-needed basis as, for example, upon encountering a situation where the navigation system 125 loses satellite signals or a line-of-sight relationship is lost.

In a second example scenario in accordance with the disclosure, the driver 115 of the vehicle 165 may store information about a remaining portion of the travel route, at an intermediate location along the travel route, such as, for example, at the road junction 135. Information about the remaining portion of the travel route may, for example, be generated by the navigation system 170 of the vehicle 165 (based on satellite signals) and provided to the driver 115 via the navigation system 125 of the vehicle 105. In the illustrated scenario, the satellite signals that are blocked by the building 145 and unavailable to the navigation system 125 of the vehicle 105, is available to the navigation system 170 of the vehicle 165.

The information about the remaining portion of the travel route may be provided by the navigation system 170 of the vehicle 165 to the navigation system 125 of the vehicle 105 via a one-time information transfer procedure and/or via a live stream information transfer procedure. The one-time information transfer procedure may be executed, for example, in response to the driver 115 seeking help. Upon receiving the information from the navigation system 170 of the vehicle 165, the vehicle 105 may desist from following the vehicle 165 and may instead travel independently to the destination. The vehicle 105 may arrive at the destination either ahead of the vehicle 165, after the vehicle 165, or substantially at the same time as the vehicle 165.

The live stream information transfer procedure may be initiated, for example, in response to the driver 115 seeking help. In one case, the live stream information transfer procedure is sustained for the remaining part of travel on the travel route. In another case, the live stream information transfer procedure is terminated when the navigation system 125 of the vehicle 105 provides an indication that help is no longer needed (such as, for example, when satellite signal reception is regained).

In another example scenario in accordance with the disclosure, the navigation system 125 of the vehicle 105 may assist the driver 115 by providing information obtained from the computer 185 or from a cloud storage device (not shown). The information provided by the computer 185 (and/or the cloud storage device) may be in the form of end-to-end travel route information of the vehicle 165 or route information pertaining to a section of the travel route yet to be traversed by the vehicle 165.

In a first example scenario, information about the end-to-end travel route may be stored in the computer 185 (and/or the cloud storage device) by various entities, such as, for example, by the driver 180 of the vehicle 165, or an individual associated with the vehicle 165. An example of an individual associated with the vehicle 165 is a vehicle dispatcher (when the vehicle 165 is a rental vehicle (taxi, limousine, etc.) or a ride-hail vehicle (Uber®, Lyft®, etc.)). The information stored in the computer 185 (and/or the cloud storage device) may be provided to the navigation system 125 of the vehicle 105 on an as-needed basis as, for example, when the driver 115 seeks help.

In a second example scenario, the navigation system 170 of the vehicle 165 may store information about a remaining portion of the travel route in the computer 185, in real-time, as the vehicle 165 moves along the travel route. The information may be made accessible by the computer 185, to the navigation system 125 of the vehicle 105, for use if needed by the navigation system 125. In an example implementation, the information stored in the computer 185 by the navigation system 170 of the vehicle 165 may be generated by the navigation system 170 in the form of breadcrumbs.

The breadcrumbs may be generated by a breadcrumb dropping procedure executed by the navigation system 170 in response to an action initiated by the driver 180 upon the navigation system 170. The navigation system 170 may execute the breadcrumb dropping procedure by dropping virtual pins (every second, for example) along the travel route as the vehicle 165 is moving, thereby creating a log of every inch (for example) of the travel route traversed by the vehicle 165.

The breadcrumb dropping procedure, which may be performed with help by satellite signals, can be particularly helpful when the vehicle 165 is traveling off-road. The road 140 shown in FIG. 1 can be, for example, an unpaved track inside a wilderness area, and the vehicle 165 may travel through the wilderness reach to reach a destination such as, for example, a cabin that is not shown in a conventional map.

In this scenario, the computer 185 may provide information to the navigation system 125 of the vehicle 105 by use of a live stream information transfer procedure. The live stream information transfer procedure may be initiated when the driver 115 of the vehicle 105 seeks help. In one case, the live stream information transfer procedure is provided in the form of a trail of breadcrumbs that is dynamically updated as the vehicle 165 travels along the travel route and is sustained for the remaining part of travel on the travel route. In another case, the live stream information transfer procedure is terminated when the navigation system 125 of the vehicle 105 provides an indication that help is no longer needed (such as, for example, when satellite signal reception is regained).

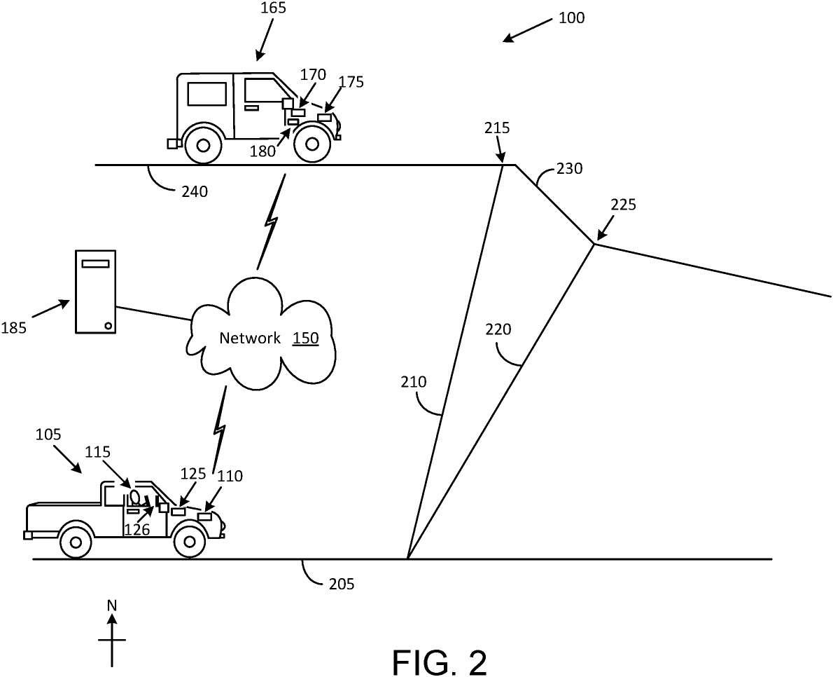

FIG. 2 illustrates a second example scenario associated with the vehicle following system 100 in accordance with an embodiment of the disclosure. The vehicle 165 in this example scenario, makes multiple stops at various locations along a travel route that includes a road 240 on which the vehicle 165 is shown moving at a first instant in time. In one case, the vehicle 165 may be operated for providing various services such as, for example, a ride-share service (Uber® car share or Lyft® care share, for example), an employee car pool, a food catering service, or a mobile store. The driver 115 of the vehicle 105 may be desiring to avail of the service offered by the vehicle 165. In another case, the vehicle 165 may be driven by an individual who is a subject of a vehicle pursuit. In this case, the vehicle 105 is a police vehicle.

The vehicle 105 may follow the vehicle 165 (or chase the vehicle 165) either on the road 240 or on a road 205. In the illustrated example scenario, the vehicle 105 is shown moving on the road 205 at the first instant in time when the vehicle 165 is on the road 240. The driver 115 may desire to rendezvous with the vehicle 165 at a location 215 before the vehicle 165 turns into a road 230. In another example scenario, the vehicle 105 may be behind the vehicle 165 on the road 240 and the driver 115 may desire to overtake the vehicle 165 and rendezvous with the vehicle 165 at the location 215.

A breadcrumb dropping procedure may be initiated by the driver 180 of the vehicle 165, or by another entity such as, for example, a law enforcement officer. Information about the breadcrumbs may be provided to the navigation system 125 of the vehicle 105 via the computer 185 and/or via vehicle-to-vehicle communications between the vehicle 105 and the vehicle 165. In one case, the breadcrumbs may be provided in the form of a trail of breadcrumbs via a live stream information transfer procedure. The information is dynamically updated as the vehicle 165 travels along the road 240. The navigation system 125 uses the trail of breadcrumbs to follow the movement of the vehicle 165. In one implementation, the navigation system 125 of the vehicle 105 may superimpose the trail of breadcrumbs upon a map displayed on the display screen of the infotainment system 126. The map may include a moving icon representing the vehicle 165.

In one scenario, the vehicle 105 travels via a road 210 and arrives at the location 215 ahead of the vehicle 165. The vehicle 105 then waits at the location 215 to rendezvous with the vehicle 165.

In another scenario, the vehicle 105 arrives late at the location 215. By then, the vehicle 165, which can be a food truck, for example, has proceeded to the next location 225 on the road 230. The location 215 and the location 225 may be two stop locations among two or more pre-designated stop locations for the vehicle 165. The pre-designated stop locations may be designated by an operator of the food truck, for example, based on providing catering service to customers at these locations. In this example, the travel route of the vehicle 165 may involve starting in the morning at a restaurant and ending in the evening at a parking garage for the vehicle 165. The navigation system 125 of the vehicle 105 will update the displayed travel route to enable the driver 115 to follow the vehicle 165 and rendezvous with the vehicle 165 at the location 225.

In yet another scenario, the driver 115 may recognize that the vehicle 105 cannot reach the location 215 on time to rendezvous with the vehicle 165. The driver 115 may request the navigation system 125 to provide an alternative route to rendezvous with the vehicle 165. The navigation system 125 may respond by providing an alternative route that involves the vehicle 105 traveling on a road 220 to rendezvous with the vehicle 165 at the location 225. The navigation system 125 may track the vehicle 165 as the vehicle 165 is moving on the road 240 and the road 230 in order to assist the driver 115 reach the location 225 on time to rendezvous with the vehicle 165.

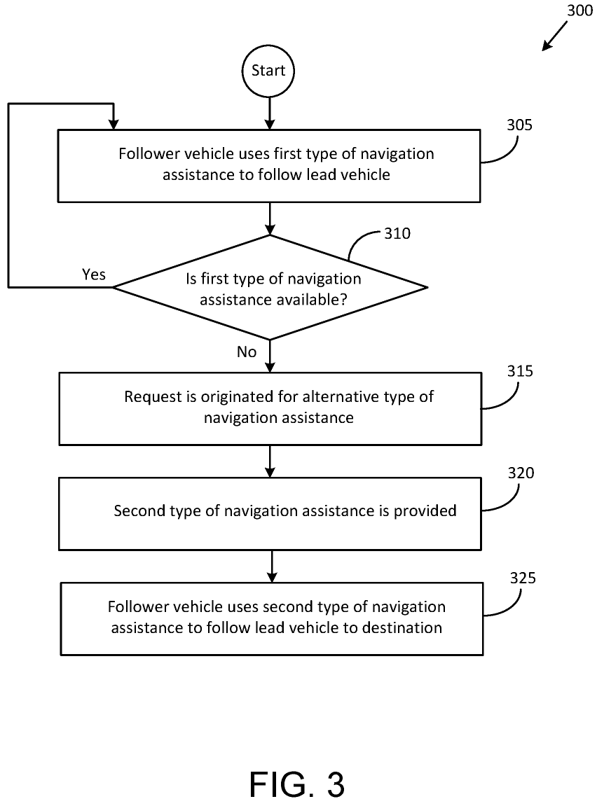

FIG. 3 illustrates a first example flowchart 300 of a method for one vehicle to follow another vehicle in accordance with an embodiment of the disclosure. The flowchart 300 (and a flowchart 400 described below) illustrates a sequence of operations that can be implemented in hardware, software, or a combination thereof. In the context of software, the operations represent computer-executable instructions stored on one or more non-transitory computer-readable media such as, for example, a memory (not shown) of the navigation system 125 of the vehicle 105, that, when executed by one or more processors such as, for example, a processor (not shown) of the navigation system 125, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. Some or all of the operations described in the flowchart 300 may be carried out by using a software application that may be downloaded into a navigation system such as, for example, the navigation system 125 of the vehicle 105.

At block 305, a navigation system of a vehicle that operates as a follower vehicle uses a first type of navigation assistance to follow a lead vehicle. One example of the first type of navigation assistance involves a line-of-sight procedure that is described above. Another example of the first type of navigation assistance involves the use of satellite signals in a manner described above.

At block 310, a determination is made whether the first type of navigation assistance is available. If the first type of navigation assistance is available, the follower vehicle may continue following the lead vehicle by use of the first type of navigation assistance. If the first type of navigation assistance is no longer available (due to loss of a line-of-sight or loss of satellite signals, for example), at block 315, a request is made by a driver of the follower vehicle (or made by a computer located in the follower vehicle, when the follower vehicle is an autonomous vehicle) for obtaining an alternative type of navigation assistance.

At block 320, the navigation system of the follower vehicle provides a second type of navigation assistance. One example of the second type of navigation assistance involves receiving a wireless signal from the lead vehicle or from a computer such as, for example, a cloud computer. The wireless signal provides travel route information to the follower vehicle in the manner described above. Another example of the second type of navigation assistance involves receiving from a computer (such as, for example, a cloud computer), travel route information derived from breadcrumbs generated by a device such as, for example, a navigation system of the lead vehicle.

At block 325, the driver of the follower vehicle (or a computer of an autonomous vehicle, when the follower vehicle is an autonomous vehicle) uses the second type of navigation assistance to follow the lead vehicle to a destination.

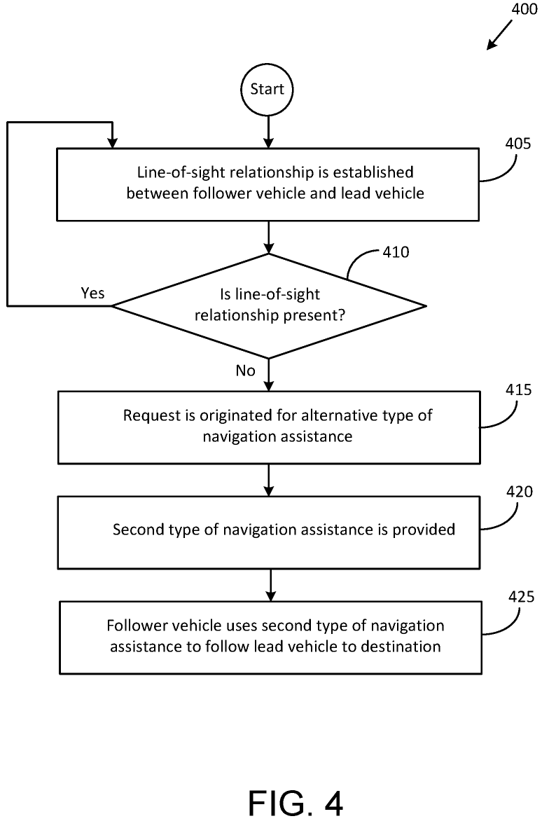

FIG. 4 illustrates a second example flowchart 400 of another method for one vehicle to follow another vehicle in accordance with an embodiment of the disclosure. At block 405, a line-of-sight relationship is established between a first vehicle that operates as a follower vehicle and a second vehicle that operates as a lead vehicle on a travel route.

At block 410, a determination is made whether the line-of-sight relationship is present. If the line-of-sight relationship is present, the follower vehicle may follow the lead vehicle by use of the line-of-sight relationship. If the line-of-sight relationship is not present (due to an obscuring object, for example), at block 415, a request is made by a driver of the follower vehicle (or made by a computer located in the follower vehicle, when the follower vehicle is an autonomous vehicle) for obtaining an alternative type of navigation assistance.

At block 420, the navigation system of the follower vehicle provides a second type of navigation assistance. One example of the second type of navigation assistance involves receiving a wireless signal from the lead vehicle or from a computer such as, for example, a cloud computer. The wireless signal provides travel route information to the follower vehicle in the manner described above. Another example of the second type of navigation assistance involves receiving from a computer (such as, for example, a cloud computer), travel route information derived from breadcrumbs generated by a device such as, for example, a navigation system of the lead vehicle.

At block 425, the driver of the follower vehicle (or a computer of an autonomous vehicle, when the follower vehicle is an autonomous vehicle) uses the second type of navigation assistance to follow the lead vehicle to a destination.

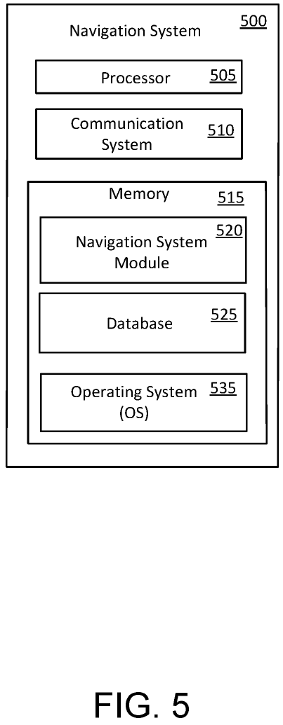

FIG. 5 shows some example components that may be included in a navigation system 500 in accordance with disclosure. The navigation system 500 can be implemented in various ways. In a first example implementation, the navigation system 500 is implemented in the form of the navigation system 125 located in the vehicle 105 (a follower vehicle). In a second example implementation, the navigation system 500 is implemented in the form of the navigation system 170 located in the vehicle 165 (a lead vehicle). In a third example implementation, the navigation system 500 is implemented in a universal configuration that may be located in either a follower vehicle or a lead vehicle. The universal configuration can allow the navigation system 500 to perform certain actions associated with a follower vehicle such as, for example, detecting a loss of a first type of navigation assistance, requesting an alternative type of navigation assistance, and assisting the driver of the follower vehicle to follow the lead vehicle. These actions may be based on an express approval of the driver, or based on a user-defined parameter or preference to, for instance, provide assistance without exception or when certain criteria or circumstances are met (e.g, a known contact, time of day, within a geofences or otherwise identified area, etc.). The universal configuration can also allow the navigation system 500 to perform certain actions associated with a lead vehicle such as, for example, providing an alternative type of navigation assistance to a follower vehicle and transferring travel route information to a computer (a cloud computer, for example). In a fourth example implementation, the navigation system 500 is implemented in the personal device 120.

In the illustrated example configuration, the navigation system 500 includes a processor 505, a communication system 510, and a memory 515. The communication system 510 can include a transceiver that allows the navigation system 500 to communicate with various components such as, for example, the computer 185 and/or the personal device 120.

Communications between the navigation system 500 and various components in a vehicle in which the navigation system 500 may be located can be carried out over a bus (not shown). The bus can be implemented using one or more of various wired and/or wireless technologies. For example, the bus can be a vehicle bus that uses a controller area network (CAN) bus protocol, a Media Oriented Systems Transport (MOST) bus protocol, and/or a CAN flexible data (CAN-FD) bus protocol. Some or all portions of the bus may also be implemented using wireless technologies such as Bluetooth®, Zigbee®, UWB, or near-field-communications (NFC), cellular, Wi-Fi, Wi-Fi direct, machine-to-machine communication, and/or man-to-machine communication.

Communications between the navigation system 500 and various components that are not a part of a vehicle (such as, for example, the computer 185 and the personal device 120) may be carried out using various types of wireless communication formats such as, for example, TCP-IP, Wi-Fi and Wi-Fi direct.

The memory 515, which is one example of a non-transitory computer-readable medium, may be used to store an operating system (OS) 535 and one or more code modules such as a navigation system module 520. The code modules can be provided in the form of computer-executable instructions that are executed by the processor 505 for performing various operations in accordance with the disclosure. The memory 515 may also include a database 525 that can be used to store information such as, for example, travel route information and breadcrumbs.

The processor 505 can execute the navigation system module 520 to perform various operations in accordance with the disclosure such as, for example, the operations included in the flowchart 300 and the flowchart 400.

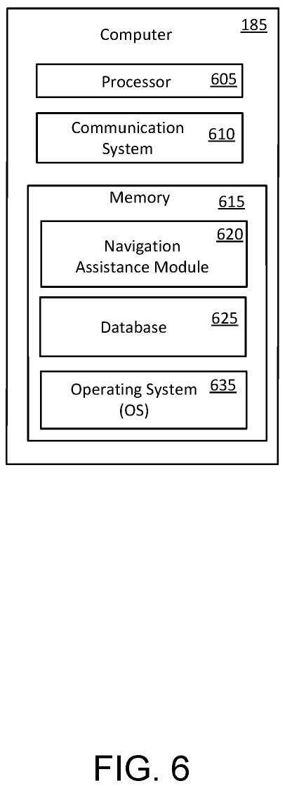

FIG. 6 shows some example components that may be included in the computer 185 in accordance with disclosure. In the illustrated example configuration, the computer 185 includes a processor 605, a communication system 610, and a memory 615. The communication system 610 can include a transceiver that allows the computer 185 to communicate with various components such as, for example, the navigation system 125, the navigation system 170, and/or the personal device 120.

Communications between the computer 185 and the various components may be carried out using various types of wireless communication formats such as, for example, TCP-IP, Wi-Fi and Wi-Fi direct.

The memory 615, which is another example of a non-transitory computer-readable medium, may be used to store an operating system (OS) 635 and one or more code modules such as a navigation assistance module 620. The code modules can be provided in the form of computer-executable instructions that are executed by the processor 605 for performing various operations in accordance with the disclosure. The memory 615 may also include a database 625 that can be used to store information such as, for example, travel route information and breadcrumbs provided by the vehicle 165.

The processor 605 can execute the navigation assistance module 620 to perform various operations in accordance with the disclosure such as, for example, receiving travel route information (including breadcrumbs) from the vehicle 165 and providing travel route information to the navigation system 125 of the vehicle 105.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” or “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, such as the processor 505 and the processor 605, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device such as the memory 515 or the memory 615, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not in function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
providing a first routing direction for a first vehicle that is following a travel route of a second vehicle, said first routing direction based on a first type of navigation assistance;
detecting, by the first vehicle, a loss of the first type of navigation assistance; and
providing a second routing direction to enable the first vehicle to rendezvous with the second vehicle at a first location on the travel route, said second routing direction based on a second type of navigation assistance.

2. The method of claim 1, wherein the first type of navigation assistance is based on a satellite signal.

3. The method of claim 2, wherein the second type of navigation assistance is based on a wireless signal containing information of the travel route of the second vehicle.

4. The method of claim 3, wherein the wireless signal containing information of the travel route of the second vehicle is generated by at least one of a first device located in the second vehicle or a second device located outside the second vehicle.

5. The method of claim 3, wherein the wireless signal is one of a cellular signal or a Wi-Fi signal.

6. The method of claim 2, further comprising:
identifying, by the second vehicle, the first location based on the travel route of the second vehicle.

7. The method of claim 1, further comprising:
identifying, by the second vehicle, the first location based on one or more predesignated stop locations for the second vehicle on the travel route.

8. A method comprising:
detecting, by a follower vehicle, a loss of a first type of navigation assistance while moving on a travel route;
requesting, by the follower vehicle, a second type of navigation assistance from a lead vehicle for rendezvousing with the lead vehicle at a first location on the travel route; and
receiving from the lead vehicle, by the follower vehicle, the second type of navigation assistance that enables the follower vehicle to rendezvous with the lead vehicle at the first location.

9. The method of claim 8, wherein the second type of navigation assistance provided by the lead vehicle to the follower vehicle comprises breadcrumbs generated by the lead vehicle along the travel route.

10. The method of claim 8, wherein the second type of navigation assistance provided by the lead vehicle to the follower vehicle comprises navigation assistance provided to the follower vehicle via vehicle-to-vehicle communications.

11. The method of claim 10, wherein second type of navigation assistance provided via vehicle-to-vehicle communications includes execution of a one-time information transfer procedure and/or a live stream information transfer procedure.

12. The method of claim 8, further comprising:
identifying, by the follower vehicle, a time factor that prevents rendezvousing with the lead vehicle at the first location;
requesting, by the follower vehicle, a routing direction for rendezvousing with the lead vehicle at a second location on the travel route; and
receiving from the lead vehicle, by the follower vehicle, the routing direction for the follower vehicle to rendezvous with the lead vehicle at the second location.

13. The method of claim 12, further comprising:
determining, by the lead vehicle, the routing direction based on one or more predesignated stop locations for the lead vehicle on the travel route.

14. The method of claim 8, wherein the lead vehicle is one of a first motor vehicle or a first water craft and the follower vehicle is one of a second motor vehicle or a second water craft.

15. A first vehicle comprising:
a vehicle computer;
a communication system; and
a navigation system comprising:
a memory that stores computer-executable instructions; and
a processor configured to access the memory and execute the computer-executable instructions to:
receive a first routing direction for following a travel route of a second vehicle, said first routing direction based on a first type of navigation assistance;
detect a loss of the first type of navigation assistance; and
receive a second routing direction based on a second type of navigation assistance, the second routing direction enabling the first vehicle to rendezvous with the second vehicle at a first location on the travel route.

16. The first vehicle of claim 15, wherein the first type of navigation assistance is based on satellite signals and the second type of navigation assistance is based on a wireless signal containing information of the travel route of the second vehicle.

17. The first vehicle of claim 16, wherein the processor is configured to access the memory and execute further computer-executable instructions to:
identifying a time factor that prevents rendezvousing with the second vehicle at the first location;
transmitting to the second vehicle, a request for a third routing direction to rendezvous with the second vehicle at a second location on the travel route; and
receiving, from the second vehicle, the third routing direction to rendezvous with the second vehicle at the second location.

18. The first vehicle of claim 15, wherein the navigation system is one of an apparatus installed in the first vehicle or a portable device carried into the first vehicle.

19. The first vehicle of claim 15, wherein the travel route of the second vehicle is on one of land or water.

20. The first vehicle of claim 15, wherein the first vehicle is one of a first motor vehicle or a first water craft.
